(19) United States
(12) Patent Application Publication
(10) Pub. No.: US 2021/0327004 A1
(43) Pub. Date: Oct. 21, 2021

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventors: Nozomi KANEKO, Nagoya-shi (JP); Aya ONODERA, Nagoya-shi (JP); Yuki TATSUMOTO, Nagoya-shi (JP); Tsuyoshi TAKENAMI, Nagoya-shi (JP)

(73) Assignee: TOYOTA JIDOSHA KABUSHIKI KAISHA, Toyota-shi (JP)

(21) Appl. No.: 17/223,663

(22) Filed: Apr. 6, 2021

(30) Foreign Application Priority Data
Apr. 15, 2020 (JP) 2020-073024

(51) Int. Cl. G06Q 50/00; G06K 9/62; G06K 9/00; G06N 20/00; H04W 4/21

(52) U.S. Cl. CPC G06Q 50/01; G06K 9/6202; H04W 4/21; G06N 20/00; G06K 9/00791

(57) ABSTRACT

In a social networking service, a controller is provided which is configured to perform: obtaining an image posted by a user; and storing, in a storage medium, at least one first image having the same feature as a feature of the image posted by the user among images taken by a camera which is provided in a vehicle associated with the user and which is installed toward an outside of the vehicle.

### CROSS REFERENCE TO THE RELATED APPLICATION

This application claims the benefit of Japanese Patent Application No. 2020-073024, filed on Apr. 15, 2020, which is hereby incorporated by reference herein in its entirety.

### BACKGROUND

### Technical Field

The present disclosure relates to an information processing apparatus, an information processing method, and a system.

### Description of the Related Art

There has been known a technique in which shooting conditions such as position information for specifying a shooting point, an orientation of a shooting target (object), a range in which shooting is performed, the number of shots, a shooting interval, etc., have been inputted, so that a picture is automatically taken when a preset shooting point is reached (for example, see Patent Literature 1).

### CITATION LIST

### Patent Literature

Patent Literature 1: Japanese Patent Application Laid-Open Publication No. 2001-257920

### SUMMARY

An object of the present disclosure is to store images preferred by a user.

One aspect of the present disclosure is directed to an information processing apparatus including a controller configured to perform:

obtaining an image posted by a user in a social networking service; and

storing, in a storage medium, a first image having the same feature as a feature of the image posted by the user among images taken by a camera that is provided in a vehicle associated with the user and installed toward an outside of the vehicle.

Another aspect of the present disclosure is directed to an information processing method for causing a computer to perform:

obtaining an image posted by a user in a social networking service; and

storing, in a storage medium, a first image having the same feature as a feature of the image posted by the user among images taken by a camera that is provided in a vehicle associated with the user and installed toward an outside of the vehicle.

A further aspect of the present disclosure is directed to a system comprising:

a server configured to manage a social networking service; and

an in-vehicle device provided in a vehicle associated with a user;

wherein the in-vehicle device includes a controller configured to perform:

obtaining an image posted by the user in the social networking service from the server; and

storing, in a storage medium, a first image having the same feature as a feature of the image posted by the user among images taken by a camera that is provided in the vehicle and installed toward an outside of the vehicle.

In addition, a still further aspect of the present disclosure is a program executed by the information processing apparatus or a storage medium storing the program in a non-transitory manner.

According to the present disclosure, images preferred by a user can be stored.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of an in-vehicle device, a user terminal, and a server which together constitute the system according to the embodiment;

FIG. 3 is a diagram illustrating a functional configuration of the in-vehicle device;

FIG. 4 is a diagram illustrating a functional configuration of the user terminal;

FIG. 5 is a sequence diagram of a system as a whole according to a first embodiment;

FIG. 6 is a flowchart of processing in which an in-vehicle device according to the first embodiment uploads an image to a server;

FIG. 7 is a diagram illustrating a functional configuration of the in-vehicle device;

FIG. 8 is a sequence diagram of a system as a whole according to a second embodiment;

FIG. 9 is a flowchart of processing in which an in-vehicle device according to the second embodiment uploads images to a server;

FIG. 10 is a sequence diagram of a system as a whole according to a third embodiment; and

FIG. 11 is a flowchart of processing in which a user terminal according to the third embodiment uploads images to a server.

### DESCRIPTION OF THE EMBODIMENTS

A controller included in an information processing apparatus, which is one aspect of the present disclosure, obtains an image posted by a user in a social networking service (SNS). This image may be either a still image or a moving image. Here, note that when the image posted by the user is obtained, the number of times other users have pressed social buttons for the posted image can also be obtained.

In addition, the controller causes a storage medium to store images which are taken by a camera provided in a vehicle and configured to image an outside of the vehicle, and which have the same feature as that of the image posted by the user. The camera is, for example, a drive recorder. Moreover, a smart phone can also be used as the camera by being fixed to the vehicle with a camera of the smart phone directed to the outside of the vehicle. Here, in a general drive recorder, images exceeding a storage capacity cannot be recorded, and hence, old images are overwritten with new images. Therefore, even if an image such as a landscape preferred by the user is included in the old images, it may be overwritten with a new image. Further, in the general drive recorder, it takes time and effort to search for the landscape preferred by the user at a later time. In contrast to this, the information processing apparatus according to the present disclosure causes the storage medium to store those images which are taken by the camera and which have the same feature as that of the image posted by the user. In this way, by separately storing the images in the storage medium, it is possible to prevent the images from being overwritten with new images. Furthermore, it is possible to save the time and effort of searching for the images later. The images stored in the storage medium may be posted to an SNS, for example. Posting to the SNS may be automatically performed by the information processing apparatus, or may be performed by the user. Still further, the user may select the images to be posted to the SNS from among the stored images.

The feature of an image may be a feature amount thereof. The feature amount may be obtained based on, for example, color, texture, or context. The controller may obtain the feature amount from the image, and classify the image by pattern matching of the feature amount, for example. In addition, the image may be classified for each imaging target such as mountain, river, sea, sunset, rain or the like. Then, an image belonging to the same classification as the image posted by the user may be set as “an image having the same feature as that of the image posted by the user”. For example, in cases where the user posts an image of sea to the SNS, when an image of sea is taken by the camera, the image may be determined as an image having the same feature, and stored in the storage medium. Further, for example, by performing machine learning based on images posted by the user, it may be determined whether or not an image taken by the camera has the same feature as those of the images posted by the user. For example, the images posted to the SNS by the user may be learned by using deep learning. Here, note that a learning method is not limited to this. Then, the learning result may be used to determine whether or not the image taken by the camera has the same feature.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

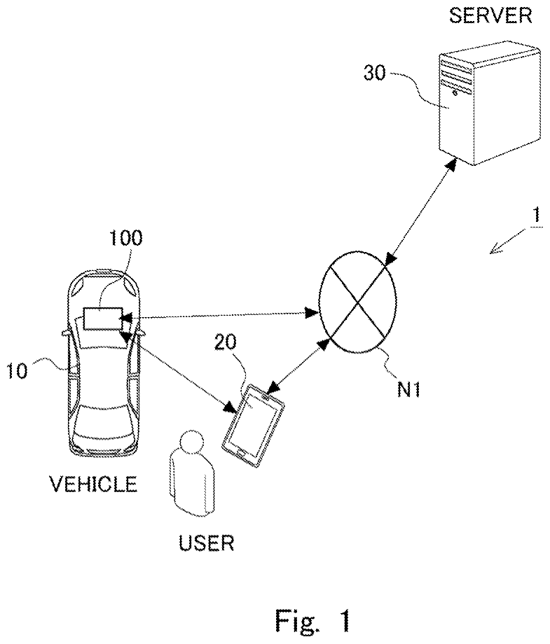

FIG. 1 is a view illustrating a schematic configuration of a system 1 according to a first embodiment. The system 1 is configured such that when there is an image having the same feature as an image posted to an SNS by a user in the past among images taken by a camera mounted on a vehicle 10, the image is stored in a storage unit. Accordingly, the vehicle 10 will automatically store user's preferred images without the user having to take photographs himself or herself. A user terminal 20 illustrated in FIG. 1 is a terminal that allows the user to post information to the SNS and to browse the SNS. The user is a registered user of the SNS. In addition, the user is a user who takes the vehicle 10 or a user who drives the vehicle 10.

In the example of FIG. 1, the system 1 includes the vehicle 10 with an in-vehicle device 100 mounted therein, the user terminal 20, and a server 30. The in-vehicle device 100, the user terminal 20 and the server 30 are connected to one another by means of a network N1. The network N1 is, for example, a worldwide public communication network such as the Internet, but a wide area network (WAN) or other communication networks may be adopted. In addition, the network N1 may include a telephone communication network such as a mobile phone network, and a wireless communication network such as Wi-Fi (registered trademark) or the like. Also, the in-vehicle device 100 and the user terminal 20 may be connected to each other by means of short-range wireless communication such as Bluetooth (registered trademark) or the like. Here, note that one user terminal 20 is exemplarily illustrated in FIG. 1, but a user terminal 20 may be carried by each of a plurality of users, so that the number of user terminals 20 may be equal to the number of users. Also, FIG. 1 illustrates one vehicle 10 as an example, but there may be a plurality of vehicles 10.

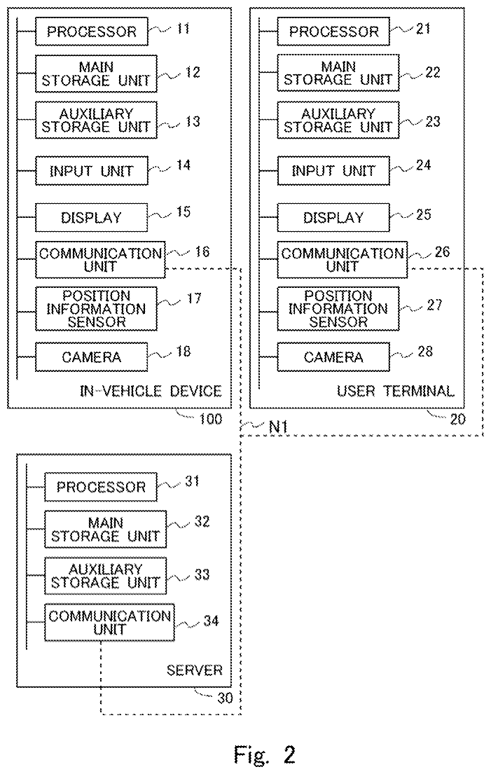

Hardware configurations of the in-vehicle device 100, the user terminal 20 and the server 30 will be described based on FIG. 2. FIG. 2 is a block diagram schematically illustrating an example of the configuration of each of the in-vehicle device 100, the user terminal 20 and the server 30, which together constitute the system 1 according to the present embodiment.

The server 30 has a configuration of a general computer. The server 30 includes a processor 31, a main storage unit 32, an auxiliary storage unit 33, and a communication unit 34. These components are connected to one another by means of a bus. The server 30 is, for example, a server that manages the SNS or a server that is able to obtain information on the SNS.

The processor 31 is a central processing unit (CPU), a digital signal processor (DSP), or the like. The processor 31 controls the server 30 thereby to perform various information processing operations. The main storage unit 32 is a random access memory (RAM), a read only memory (ROM), or the like. The auxiliary storage unit 33 is an erasable programmable ROM (EPROM), a hard disk drive (HDD), a removable medium, or the like. The auxiliary storage unit 33 stores an operating system (OS), various kinds of programs, various types of tables, and the like. The processor 31 loads a program(s) stored in the auxiliary storage unit 33 into a work area of the main storage unit 32 and executes the program(s), so that each component of the system is controlled through the execution of the program(s). As a result, the server 30 realizes functions that match predetermined purposes. The auxiliary storage unit 33 is an example of the storage medium. The main storage unit 32 and the auxiliary storage unit 33 are computer-readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the in-vehicle device 100 and the user terminal 20 via the network N1. The communication unit 34 is, for example, a local area network (LAN) interface board, a radio or wireless communication circuit for radio or wireless communication, or the like. The LAN interface board and the radio or wireless communication circuit are connected to the network N1.

Here, note that a series of processing performed by the server 30 may be performed by hardware or may be performed by software.

Next, the user terminal 20 will be described. The user terminal 20 is a small computer such as, for example, a smart phone, a mobile phone, a tablet terminal, a personal information terminal, a wearable computer (a smart watch or the like), or a personal computer (PC). The user terminal 20 includes a processor 21, a main storage unit 22, an auxiliary storage unit 23, an input unit 24, a display 25, a communication unit 26, a position information sensor 27, and a camera 28. These components are connected to one another by means of a bus. The processor 21, the main storage unit 22 and the auxiliary storage unit 23 are the same as the processor 31, the main storage unit 32 and the auxiliary storage unit 33 of the server 30, and thus, the description thereof is omitted.

The input unit 24 is a means or unit for receiving an input operation performed by the user, and is, for example, a touch panel, a mouse, a keyboard, a push button, or the like. The display 25 is a means or unit for presenting information to the user, and is, for example, a liquid crystal display (LCD), an electroluminescence (EL) panel, or the like. The input unit 24 and the display 25 may be configured as one touch panel display. The communication unit 26 is a communication means or unit for connecting the user terminal 20 to the network N1. The communication unit 26 is, for example, a circuit for communicating with other devices (e.g., the in-vehicle device 100, the server 30 or the like) via the network N1 by making use of a mobile communication service (e.g., a telephone communication network such as 5G (5th Generation), 4G (4th Generation), 3G (3rd Generation), LTE (Long Term Evolution) or the like), or a wireless communication network such as Wi-Fi (registered trademark), Bluetooth (registered trademark).

The position information sensor 27 obtains position information (e.g., latitude and longitude) of the user terminal 20. The position information sensor 27 is, for example, a GPS (Global Positioning System) receiver unit, a wireless LAN communication unit, or the like. The camera 28 takes or photographs images by using an imaging element such as for example a CCD (Charge Coupled Device) image sensor, a CMOS (Complementary Metal Oxide Semiconductor) image sensor or the like. The images obtained by the photographing may be either still images or moving images.

Then, the in-vehicle device 100 of the vehicle 10 will be described. The in-vehicle device 100 includes a processor 11, a main storage unit 12, an auxiliary storage unit 13, an input unit 14, a display 15, a communication unit 16, a position information sensor 17, and a camera 18. These components are connected to one another by means of a bus. The processor 11, the main storage unit 12, the auxiliary storage unit 13, the input unit 14, the display 15, the communication unit 16, the position information sensor 17, and the camera 18 are similar to the processor 21, the main storage unit 22, the auxiliary storage unit 23, the input unit 24, the display 25, the communication unit 26, the position information sensor 27, and the camera 28 of the user terminal 20, and thus, the description thereof is omitted. Here, note that the processor 11 is an example of a controller. In addition, the camera 18 is an example of a camera. Also, the auxiliary storage unit 13 is an example of a storage medium. The camera 18 is installed toward the outside of the vehicle 10 so that the angle of view thereof is around the vehicle 10.

Next, the function of the server 30 will be described. The server 30 is a server that manages posting to the SNS and browsing of the SNS. The server 30 is able to communicate with the in-vehicle device 100 and the user terminal 20 via the network N1. The server 30 stores, in the auxiliary storage unit 33, the posts of each user, the positions where each user posted, and the like. The server 30 provides information on the SNS based on a request from the user terminal 20. For example, when a user has made a post containing an image, the server 30 stores the image in the auxiliary storage unit 33 in association with a user account, which is an identifier unique to the user. In addition, the server 30 stores, in the auxiliary storage unit 33, information indicating that another user has responded positively to the post. For example, the server 30 stores, in the auxiliary storage unit 33, information indicating that a social button has been pressed for the post (e.g., a like button has been pressed or the number of stars has been inputted).

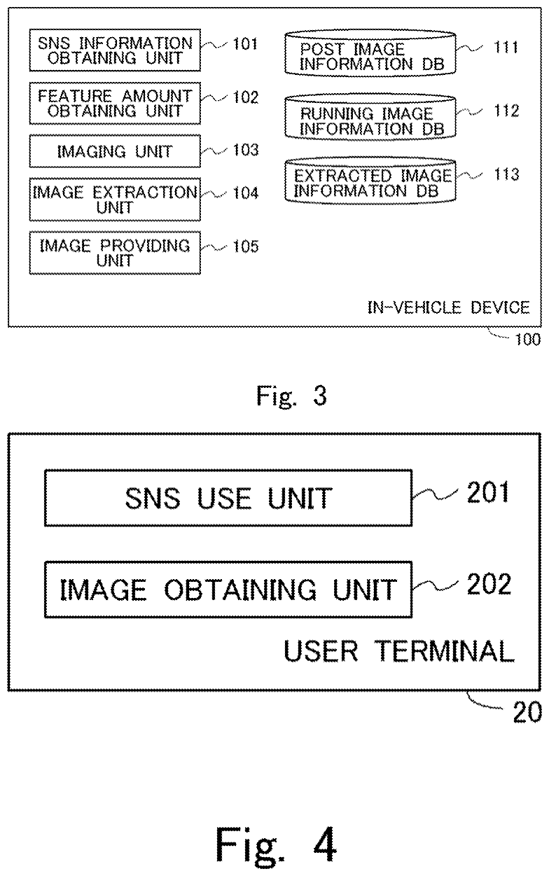

The function of the in-vehicle device 100 of the vehicle 10 will be described. FIG. 3 is a diagram illustrating a functional configuration of the in-vehicle device 100. The in-vehicle device 100 includes, as its functional components, an SNS information obtaining unit 101, a feature amount obtaining unit 102, an imaging unit 103, an image extraction unit 104, an image providing unit 105, a post image information database (DB) 111, a running image information database (DB) 112, and an extracted image information database (DB) 113. The processor 11 of the in-vehicle device 100 performs the processes of the NS information obtaining unit 101, the feature amount obtaining unit 102, the imaging unit 103, the image extraction unit 104, and the image providing unit 105 by means of a computer program(s) on the main storage unit 12. However, all or part of these processes may be performed by a hardware circuit.

The post image information DB 111, the running image information DB 112 and the extracted image information DB 113 are constructed by a program(s) of a database management system (DBMS) executed by the processor 11 to manage the data stored in the auxiliary storage unit 33. The post image information DB 111, the running image information DB 112, and the extracted image information DB 113 are, for example, relational databases.

Here, note that any of the functional components of the in-vehicle device 100 or a part of the processing thereof may be performed by another computer connected to the network N1.

The SNS information obtaining unit 101 obtains SNS information from server 30. The SNS information referred to herein is information related to an image posted to the SNS by the user who is driving the vehicle 10. The SNS information obtaining unit 101 specifies an SNS account of the user who is driving the vehicle 10 by performing short-range wireless communication with the user terminal 20, for example. The SNS account of the user has been given to the user by the server 30 in advance, and has been stored in the auxiliary storage unit 23 of the user terminal 20, for example. Alternatively, the user may input the SNS account via the input unit 14 of the in-vehicle device 100. Then, the SNS information obtaining unit 101 obtains an image associated with the SNS account of the user from the server 30. This image is the image posted to the SNS by the user who is the driver of the vehicle 10. The SNS information obtaining unit 101 stores the SNS information thus obtained in the post image information DB 111 which will be described later. In the post image information DB 111, images associated with the SNS account of the user have been stored.

The feature amount obtaining unit 102 obtains a feature amount of each image stored in the post image information DB 111, for example. The feature amount is obtained based on, for example, color, texture, or context. After obtaining the feature amount of each image stored in the post image information DB 111, the feature amount obtaining unit 102 stores the feature amount in the post image information DB 111. Similarly, the feature amount obtaining unit 102 obtains a feature amount of each image stored in the running image information DB 112 which will be described later, and stores the feature amount in the running image information DB 112. A method of obtaining a feature amount is not limited.

The imaging unit 103 takes pictures or images around the vehicle 10 by camera 18, and stores the images in the running image information DB 112. In the running image information DB 112, the images and the feature amounts thereof are stored. The images may be still images or moving images. For example, the imaging unit 103 may take pictures or images until the power of the vehicle 10 is turned off after short-range wireless communication has been established between the in-vehicle device 100 and the user terminal 20, or may take pictures or images only during traveling of the vehicle 10 (e.g., only when the speed of the vehicle 10 is greater than 0).

The image extraction unit 104 compares the feature amounts of images stored in the post image information DB 111 with the feature amounts of images stored in the running image information DB 112 thereby to extract images having the same feature as the image posted to the SNS by the user from among the images stored in the running image information DB 112. The images having the same feature are, for example, images that can be said to be similar. For example, the image extraction unit 104 may extract images having the same feature by means of pattern matching. The images thus extracted by the image extraction unit 104 are stored in the extracted image information DB 113. The images to be stored in the extracted image information DB 113 may be associated with the posted image that has been determined to have the same feature. Here, note that the images, which have been stored in the running image information DB 112 and determined not to be similar to the image posted to the SNS by the user, may be deleted by the image extraction unit 104.

The image providing unit 105 transmits images stored in the extracted image information DB 113 to the user terminal 20 or the server 30. The image providing unit 105 may transmit the images to the server 30 in order to post the image to the SNS, for example, every predetermined period of time or every time the images are stored in the extracted image information DB 113. In addition, the image providing unit 105 may transmit images stored in the extracted image information DB 113 to the user terminal 20 when the provision of the images is requested from the user terminal 20. The image providing unit 105 may provide images to the server 30 only when the user permits the transmission of the images via the user terminal 20.

Then, the function of the user terminal 20 will be described. FIG. 4 is a diagram illustrating a functional configuration of the user terminal 20. The user terminal 20 includes, as its functional components, an SNS use unit 201 and an image obtaining unit 202. The processor 21 of the user terminal 20 performs the processing of the SNS use unit 201 and the image obtaining unit 202 by means of a computer program(s) on the main storage unit 22. However, the SNS use unit 201 and the image obtaining unit 202 or a part of the processing thereof may be performed by a hardware circuit.

The SNS use unit 201 causes the display 25 to display an operation screen, and transmits, to the server 30, information corresponding to an input to the input unit 24 by the user. For example, the SNS use unit 201 displays the operation screen for the SNS or the like on a touch panel display, and, when the user performs any input on the operation screen or the like, transmits the information corresponding to the input to the server 30. For example, the user can post an image taken by the camera 28.

In addition, the SNS use unit 201 can cause the display 25 to display the images that have been published on the SNS. In cases where a predetermined input is made by the user so as to display images on the display 25, the SNS use unit 201 requests the server 30 to provide the images. Then, when the server 30 transmits the images in response to the request, the SNS use unit 201 displays the images on the display 25.

The image obtaining unit 202 obtains images from the image providing unit 105 of the in-vehicle device 100. The images thus obtained may be displayed on the display 25 so as to be selectable by the user. For example, when the user taps an image displayed on the display 25, the image may be transmitted to the server 30 as a post to the SNS.

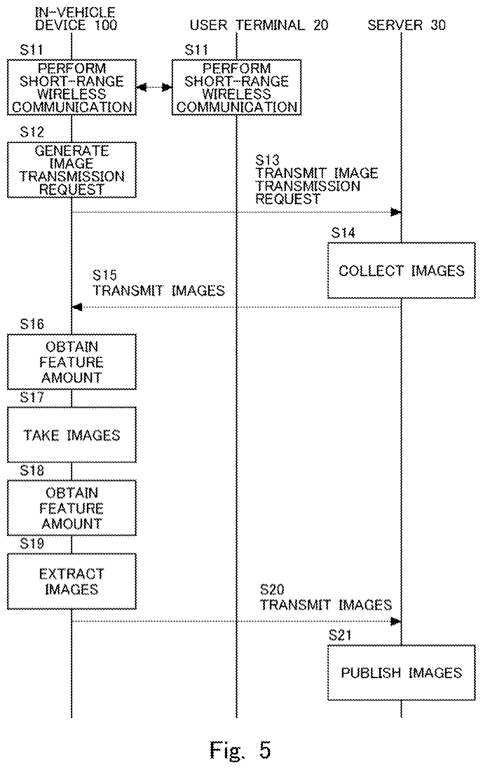

Now, the overall processing of the system 1 will be described. FIG. 5 is an overall sequence diagram of the system 1. In FIG. 5, when the user gets on the vehicle 10 while carrying the user terminal 20, the user terminal 20 and the in-vehicle device 100 perform short-range wireless communication with each other, for example (S11). Thus, information such as the SNS account of the user is transmitted from the user terminal 20 to the in-vehicle device 100. Then, an image transmission request is generated in the in-vehicle device 100 (S12). The image transmission request is information which is related to a request from the in-vehicle device 100 to the server 30, and which is for requesting transmission of the images posted by the user. The image transmission request includes, for example, the SNS account of the user and an identifier unique to the in-vehicle device 100 (hereinafter, also referred to as a vehicle ID). When the image transmission request is generated, it is transmitted from the in-vehicle device 100 to the server 30 (S13).

The server 30, which has received the image transmission request, collects the images posted by the user (S14), and transmits the images thus collected to the in-vehicle device 100 (S15). The in-vehicle device 100, which has received the images from the server 30, obtains the feature amount of each image and stores the feature amount in the auxiliary storage unit 13 (the post image information DB 111) (S16). In addition, the in-vehicle device 100 takes an image by the camera 18 (S17). The in-vehicle device 100 stores the image thus taken in the auxiliary storage unit 13, obtains the feature amount of the image, and stores the feature amount in the auxiliary storage unit 13 (the running image information DB 112) (S18). The server 30 compares the feature amount of each image stored in the post image information DB 111 with the feature amount of each image stored in the running image information DB 112. The server 30 extracts, from among the images stored in the running image information DB 112, images having the same feature as the images stored in the post image information DB 111, for example, by pattern matching (S19). In S19, the images (first images) thus extracted by the in-vehicle device 100 is stored in the extracted image information DB 113. Then, the images extracted by the in-vehicle device 100 is transmitted from the in-vehicle device 100 to the server 30 (S20). The server 30, which has received this image, publishes this image on the SNS as a post of the user (S21).

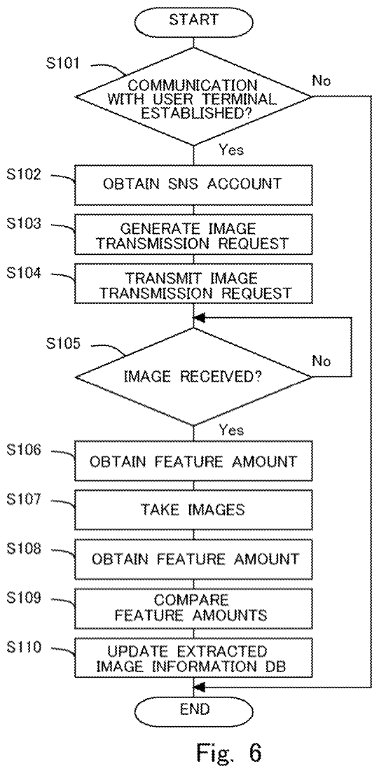

Next, the processing in which the in-vehicle device 100 uploads an image to the server 30 will be described. FIG. 6 is a flowchart of processing in which the in-vehicle device 100 according to the present embodiment uploads an image to the server 30. The provision processing illustrated in FIG. 6 is repeatedly performed at predetermined time intervals in the in-vehicle device 100. Here, the following description will be made on the assumption that the images posted by the user have been stored in the auxiliary storage unit 33 of the server 30.

In step S101, the SNS information obtaining unit 101 determines whether or not short-range wireless communication with the user terminal 20 has been established. In cases where an affirmative determination is made in step S101, the processing or routine goes to step S102, whereas when a negative determination is made, the present routine is ended. In step S102, the SNS information obtaining unit 101 obtains the SNS account of the user from the user terminal 20. In step S103, the SNS information obtaining unit 101 generates an image transmission request, which is information for requesting the server 30 to transmit an image. The image transmission request includes the SNS account of the user and the vehicle ID. Then, in step S104, the SNS information obtaining unit 101 transmits the image transmission request to the server 30.

In step S105, the SNS information obtaining unit 101 determines whether or not an image has been received from the server 30. In cases where an affirmative determination is made in step S105, the SNS information obtaining unit 101 stores the image associated with the user account in the post image information DB 111, and the routine goes to step S106. On the other hand, in cases where a negative determination is made in step S105, the processing of step S105 is performed again.

In step S106, the feature amount obtaining unit 102 obtains a feature amount from the image stored in the post image information DB 111. A method of obtaining the feature amount is not limited. The feature amount obtaining unit 102 stores the feature amount thus obtained in the post image information DB 111. In step S107, the imaging unit 103 takes a picture or image. For example, a still image may be taken at predetermined time intervals, or a moving image or video may be taken. The imaging unit 103 stores the image thus taken in the running image information DB 112. In step S108, the feature amount obtaining unit 102 obtains a feature amount from the image stored in the running image information DB 112. The feature amount thus obtained is stored in the running image information DB 112. In cases where the moving image has been stored in the running image information DB 112, for example, a still image may be cut out from the moving image at predetermined time intervals thereby to obtain a feature amount thereof. Then, in step S109, the image extraction unit 104 compares the feature amount stored in the post image information DB 111 (the feature amount of the image posted to the SNS by the user) with the feature amount stored in the running image information DB 112 (the feature amount of the image taken by the imaging unit 103). Thereafter, in step S110, the image extraction unit 104 updates the extracted image information DB 113 by storing, in the extracted image information DB 113, the image (the image taken by the imaging unit 103) whose feature amount has a predetermined matching degree. In this way, the image similar to the image uploaded to the SNS by the user is stored in the extracted image information DB 113. That is, the image that the user is highly likely to want to upload to the SNS is stored in the extracted image information DB 113.

As described above, according to the present embodiment, it is possible to automatically capture and store user's favorite scenery, etc., based on the image posted to the SNS by the user. In addition, even when the user is driving, pictures or images can be taken by means of the in-vehicle device 100, thus making it possible to more reliably capture the scenery preferred by the user. Further, since the scenery, etc., preferred by the user is stored, it is possible to save time and effort for searching later.

Here, note that, in the above description, for example, pattern matching is used to determine whether or not the images are similar, but instead of this, for example, machine learning may be used to determine whether or not the images are the user's favorite images. For example, learning by deep learning may be performed based on the images posted to the SNS by the user, and it may be determined whether or not the images taken by the in-vehicle device 100 have the same feature as the images posted to the SNS.

### Second Embodiment

In this second embodiment, the images to be stored in the in-vehicle device 100 are selected from among the images posted to the SNS by the user, based on an image for which positive responses have been obtained from other users. The positive responses mean, for example, that social buttons have been pressed by other users. For example, this may include the following: “like” buttons have been pressed by other users; the number of stars has been entered; a score has been entered, or the like. For example, the in-vehicle device 100 may store an image having the same feature as an image for which a predetermined number or more of social buttons have been pressed. The predetermined number may be a number that can be treated as popular. The predetermined number may be determined by the user, the administrator of the system 1, or the like.

The in-vehicle device 100 performs machine learning, for example, by using as input data the images posted to the SNS by the user, and using as correct answer data an image that has received a predetermined number or more of positive responses (hereinafter, referred to as an image of being popular or a popular image). Here, note that the learning is not limited to supervised learning. Further, in addition to the learning, images having the same feature as the popular image may be extracted, for example, by using pattern matching described in the first embodiment.

In this second embodiment, the configuration of the hardware thereof is the same as that of the first embodiment, and hence, the description thereof is omitted. In addition, the function of the user terminal 20 is also the same as that of the first embodiment, and hence, the description thereof is omitted. Next, the functions of the server 30 in the second embodiment will be described. The server 30 also has a function of storing positive responses from other users to user's posts, in addition to the function described in the first embodiment. For example, the server 30 stores the number of social buttons pressed on the SNS for posted images.

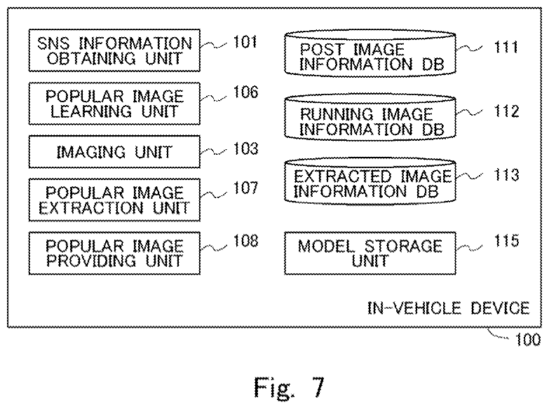

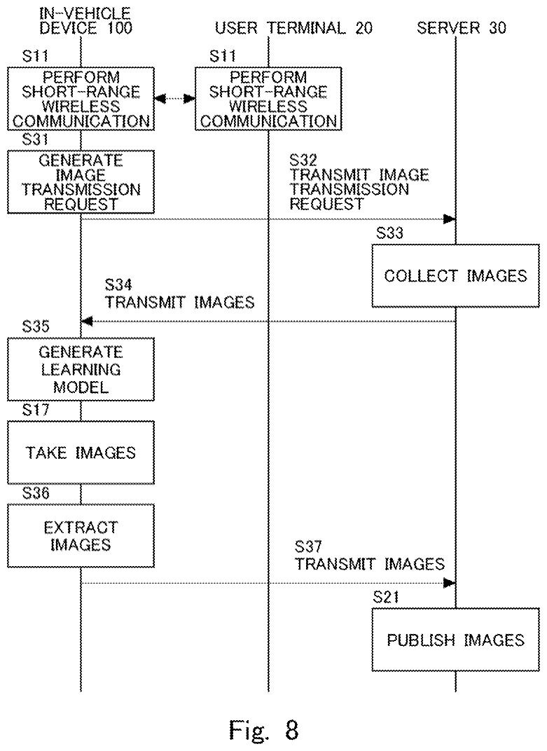

Next, the function of the in-vehicle device 100 of the vehicle 10 will be described. FIG. 7 is a diagram illustrating a functional configuration of the in-vehicle device 100. The in-vehicle device 100 includes, as its functional components, the SNS information obtaining unit 101, a popular image learning unit 106, the imaging unit 103, a popular image extraction unit 107, a popular image providing unit 108, the post image information DB 111, the running image information DB 112, the extracted image information DB 113, and a model storage unit 115. The processor 11 of the in-vehicle device 100 performs the processes of the SNS information obtaining unit 101, the popular image learning unit 106, the imaging unit 103, the popular image extraction unit 107, and the popular image providing unit 108 by means of a computer program(s) on the main storage unit 12. However, all or part of these processes may be performed by a hardware circuit. The post image information DB 111, the running image information DB 112, and the extracted image information DB 113 are the same as those in the first embodiment, and thus, the description thereof is omitted.

The model storage unit 115 stores a learning model. The learning model is a machine learning model that is generated based on the images posted by the user and an image for which a predetermined number or more of social buttons have been pressed by other users, and outputs whether or not the number of social buttons pressed is equal to or more than the predetermined number in response to an input of an image. The popular image learning unit 106 performs a phase of learning the machine learning model, and the popular image extraction unit 107 performs a phase of extracting a popular image by using the machine learning model.

Here, note that any of the functional components of the in-vehicle device 100 or a part of the processing thereof may be performed by another computer connected to the network N1.

The SNS information obtaining unit 101 obtains SNS information from the server 30. The SNS information referred to herein is information posted to the SNS by the user who is driving the vehicle 10, and is information containing an image. In addition, the SNS information includes the number of times the social buttons associated with the image have been pressed. The SNS information obtaining unit 101 stores the SNS information thus obtained in the post image information DB 111, which will be described later.

The popular image learning unit 106 performs machine learning by using as input data the images that have been posted to the SNS by the user and stored in the post image information DB 111, and using as correct answer data the images that are popular. The learning model thus generated is a learning model that outputs whether or not the number of social buttons to be pressed is equal to or greater than the predetermined number when an image is inputted. After generating the learning model, the popular image learning unit 106 stores the learning model in the model storage unit 115. Here, note that the learning by the popular image learning unit 106 is not limited to the above. Other learning methods may be employed as long as an image whose feature matches that of a popular image can be extracted from among the images taken by the imaging unit 103. The learning model may be a learning model that outputs the number of times social buttons are pressed in response to the input of an image.

The imaging unit 103 takes images around the vehicle 10 by means of the camera 18, and stores the images in the running image information DB 112. The popular image extraction unit 107 extracts an image having the same feature as the popular image from among the images stored in the running image information DB 112, based on the learning model stored in the model storage unit 115 and the images stored in the running image information DB 112. The image extracted by the popular image extraction unit 107 is stored in the extracted image information DB 113. Here, note that the popular image extraction unit 107 deletes an image that has been determined not to have the same feature as the popular image by the popular image extraction unit 107.

The popular image providing unit 108 transmits the images stored in the extracted image information DB 113 to the user terminal 20 or the server 30. For example, the popular image providing unit 108 may transmit the images to the server 30 in order to post the images to the SNS every predetermined period of time or every time the image is stored in the extracted image information DB 113. In addition, when the provision of images is requested from the user terminal 20, the popular image providing unit 108 may transmit the images stored in the extracted image information DB 113 to the user terminal 20. Further, the popular image providing unit 108 may also provide the images to the server only when the user permits.

Next, the processing of the system 1 will be described. FIG. 8 is an overall sequence diagram of the system 1. In FIG. 8, the same processes as those in FIG. 5 are denoted by the same reference numerals. In FIG. 8, when the user gets on the vehicle 10 while carrying the user terminal 20, the user terminal 20 and the in-vehicle device 100 perform short-range wireless communication with each other (S11). Thus, information such as the SNS account of the user and the like is transmitted from the user terminal 20 to the in-vehicle device 100. Then, an image transmission request is generated in the in-vehicle device 100 (S31). The image transmission request is information related to a request from the in-vehicle device 100 to the server 30, and is information for requesting the server 30 to transmit the images posted by the user and the number of times social buttons associated with the images have been pressed. The image transmission request includes, for example, the SNS account of the user and the vehicle ID. When the image transmission request is generated, it is transmitted from the in-vehicle device 100 to the server 30 (S32).

The server 30, which has received the image transmission request, collects the images posted by the user (S33), and transmits the images to the in-vehicle device 100 together with the number of times the social buttons associated with the images have been pressed (S34). The in-vehicle device 100, which has received the images from the server 30, generates a learning model based on each image and the popular image, and stores the learning model in the model storage unit 115 (S35). In addition, the in-vehicle device 100 takes pictures or images by the camera 18 (S17). The in-vehicle device 100 stores the images thus taken in the auxiliary storage unit 13 (the running image information DB 112), and extracts images having the same feature as the popular image based on the images and the learning model (S36). In S36, the images extracted by the in-vehicle device 100 are stored in the extracted image information DB 113. Then, the images extracted by the in-vehicle device 100 are transmitted from the in-vehicle device 100 to the server 30 (S37). The server 30, which has received the images, publishes the images on the SNS as a post of the user (S21).

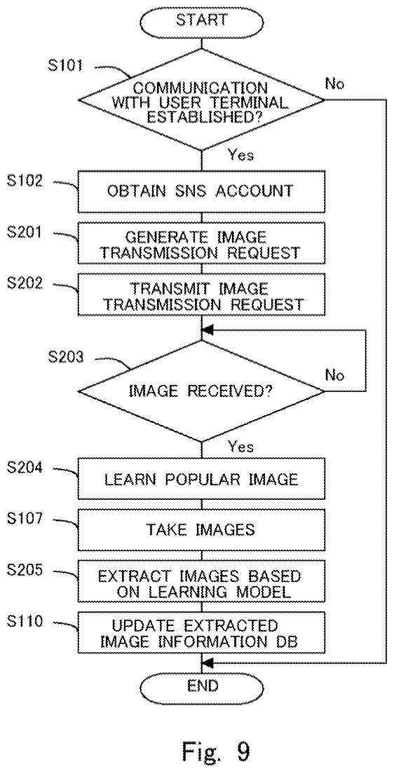

Then, the processing in which the in-vehicle device 100 uploads the images to the server 30 will be described. FIG. 9 is a flowchart of processing in which the in-vehicle device 100 according to the second embodiment uploads the images to the server 30. The provision processing illustrated in FIG. 9 is repeatedly performed at predetermined time intervals in the in-vehicle device 100. Here, note that the following description will be made on the assumption that the images posted by the user have been stored in the auxiliary storage unit 33 of the server 30. Those steps in FIG. 9 in which the same processes as those illustrated in FIG. 6 are performed are denoted by the same reference numerals, and the description thereof is omitted.

In the flowchart illustrated in FIG. 9, the processing of step S201 is executed after the processing of step S102. In step S201, the SNS information obtaining unit 101 generates an image transmission request, which is information for requesting the server 30 to transmit images. The image transmission request includes the SNS account of the user and the vehicle ID. The image transmission request also includes a request to transmit the number of times the social buttons associated with the images have been pressed. Then, in step S202, the SNS information obtaining unit 101 transmits the image transmission request to the server 30.

In step S203, the SNS information obtaining unit 101 determines whether or not the images have been received from the server 30. In cases where an affirmative determination is made in step S203, the SNS information obtaining unit 101 stores the received images in the post image information DB 111 in association with the number of times the social buttons for the images have been pressed, and the routine goes to step S204. On the other hand, in cases where a negative determination is made in step S203, the processing of step S203 is performed again.

In step S204, the popular image learning unit 106 generates a learning model from the images stored in the post image information DB 111. A learning method is not limited. The popular image learning unit 106 stores the learning model thus generated in the model storage unit 115. In step S107, the imaging unit 103 takes pictures or images. In step S205, the popular image extraction unit 107 extracts images having the same feature as the popular image, based on the images stored in the running image information DB 112 and the learning model stored in the model storage unit 115. The popular image extraction unit 107 updates the extracted image information DB 113 by storing the extracted images in the extracted image information DB 113. In this manner, the extracted image information DB 113 stores the images having the same feature as the popular image among the images uploaded to the SNS by the user. That is, the images that the user is likely to want to upload to the SNS have been stored in the extracted image information DB 113.

As described above, according to the second embodiment, it is possible to automatically capture and store scenery or the like based on an image popular to other users among the images uploaded to the SNS by the user.

Here, note that in the above description, the learning model is generated based on, for example, the images posted to the SNS by the user and the popular image, but instead of this, the learning model may be generated only from the popular image. In addition, as in the first embodiment, a feature amount of the popular image may be obtained, so that images having the same feature as the popular image may be extracted by pattern matching.

### Third Embodiment

In the first and second embodiments, examples have been mainly described in which images are automatically transmitted from the in-vehicle device 100 to the server 30. On the other hand, in a third embodiment, images are transmitted from the in-vehicle device 100 to the user terminal 20, and the images selected by the user in the user terminal 20 are transmitted to the server 30. The configuration of hardware in the third embodiment is the same as that of the above embodiments, and hence, the description thereof is omitted. In addition, the processing of the system 1 until the in-vehicle device 100 stores images in the extracted image information DB 113 is the same as that of the above embodiments.

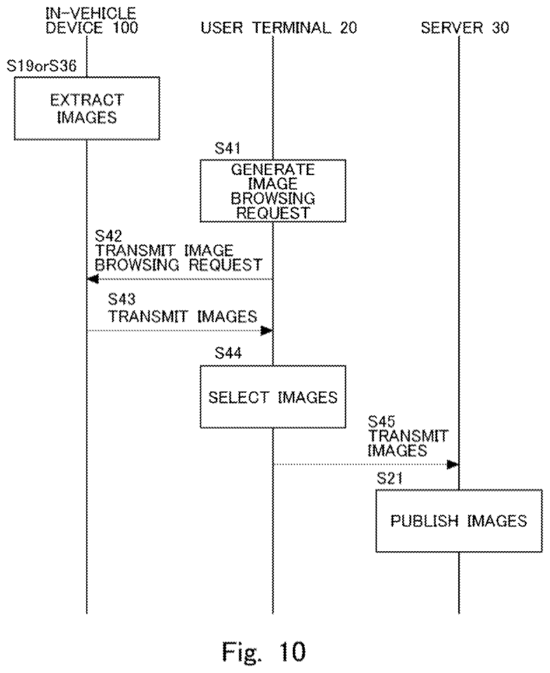

The overall processing of the system 1 will be described. FIG. 10 is an overall sequence diagram of the system 1. In FIG. 10, since the same processing is performed up to S18 in FIG. 5 or S36 in FIG. 8, the illustration and description thereof are omitted. In FIG. 10, when the user inputs to the user terminal 20 an instruction to request for browsing images, the user terminal 20 generates an image browsing request (S41). For example, an icon for generating an image browsing request is displayed on the user terminal 20, so that when the user taps this icon, the image obtaining unit 202 generates the image browsing request. The image browsing request is information for requesting transmission of the images stored in the extracted image information DB 113 of the in-vehicle device 100. The image browsing request thus generated is transmitted to the in-vehicle device 100 (S42). The in-vehicle device 100, which has received the image browsing request, transmits the images stored in the extracted image information DB 113 to the user terminal 20 (S43).

In the user terminal 20 that has received the images from the in-vehicle device 100, for example, thumbnails of the images are displayed on the display 25, so that the user can select images by tapping the thumbnails thereof (S44). The images thus selected are those images which the user wants to publish on the SNS. The selected images are transmitted to the server 30 (S45) and published on the SNS by the server 30 (S21).

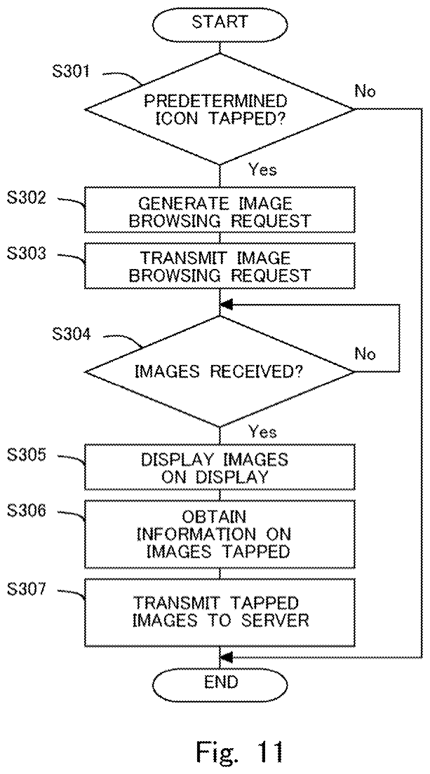

FIG. 11 is a flowchart of processing in which the user terminal 20 according to the third embodiment uploads the images to the server 30. The provision processing illustrated in FIG. 11 is repeatedly performed at predetermined time intervals in the user terminal 20. Here, note that the following description will be made on the assumption that images have been stored in the extracted image information DB 113 of the in-vehicle device 100.

In step S301, the image obtaining unit 202 determines whether or not the user has tapped a predetermined icon displayed on the display 25. The predetermined icon is an icon that is tapped by the user when the user causes the user terminal 20 to generate an image browsing request. The predetermined icon is tapped by the user when the user transmits the images to a selected server 30. In cases where an affirmative determination is made in step S301, the routine goes to step S302, whereas in cases where a negative determination is made, the present routine is ended. In step S302, the image obtaining unit 202 generates an image browsing request. Then, in step S303, the image obtaining unit 202 transmits the image browsing request to the in-vehicle device 100.

In step S304, the image obtaining unit 202 determines whether or not the images have been received from the in-vehicle device 100. In cases where an affirmative determination is made in step S304, the routine goes to step S305, whereas in cases where a negative determination is made, the processing of step S304 is performed again. In step S305, the image obtaining unit 202 displays the received images on the display 25. For example, the image obtaining unit 202 may cause the display 25 to display thumbnails that are the reduced images of the received images. In addition, the image obtaining unit 202 causes the display 25 to display a prompt to tap the thumbnails of images to be posted to the SNS, for example. At this time, for example, a radio button may be displayed so that the images selected by the user can be checked.

In step S306, the image obtaining unit 202 obtains information related to the images (second images) selected by the user, and in step S307, the image obtaining unit 202 transmits the images selected by the user to the server 30. The images transmitted from the user terminal 20 to the server 30 as described above are published on the SNS by the server 30.

As described above, according to the third embodiment, the user can select the images to be published on the SNS from among the images stored in the in-vehicle device 100. Thus, only the images preferred by the user can be published on the SNS.

Here, note that in this third embodiment, the user selects the images to be posted to the SNS from among the images displayed on the display 25 of the user terminal 20, but instead of this, the in-vehicle device 100 may display images on the display 15, so that the user can select the images to be posted to the SNS from among the images displayed on the display 15 of the in-vehicle device 100. In this case, the in-vehicle device 100 may cause the display 15 to display the thumbnails of the stored images based on an operation of the user, so that the user can tap some thumbnails to select images to be posted to the SNS. Then, the images thus selected by the user may be transmitted from the in-vehicle device 100 to the server 30.

### Other Embodiments

The above-described embodiments are merely some examples, but the present disclosure can be implemented with appropriate modifications without departing from the spirit thereof.

The processing and means (devices, units, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system. For example, the server 30 may be composed of a server that manages an SNS and a server that manages vehicle washing machine information.

In the above-mentioned embodiments, the examples have been described in which the in-vehicle device 100 functions as an information processing apparatus, but the present invention is not limited to this, and the sever 30 may function as an information processing apparatus, or the user terminal 20 may function as an information processing apparatus. In addition, the server 30, the in-vehicle device 100 and the user terminal 20 may cooperate with one another to function as an information processing apparatus.

Moreover, the feature amount obtaining unit 102 may also classify images by pattern matching of feature amounts. For example, each image may be classified according to landscapes such as mountains, rivers, seas, etc., or according to situations such as sunset, rain, etc. Then, for example, images classified into the landscapes preferred by the user among the images taken by the imaging unit 103 may be stored in the auxiliary storage unit 13.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
obtaining an image posted by a user in a social networking service; and
storing, in a storage medium, at least one first image having the same feature as a feature of the image posted by the user among images taken by a camera that is provided in a vehicle associated with the user and installed toward an outside of the vehicle.

2. The information processing apparatus according to claim 1, wherein
the controller transmits, to the social networking service, a second image selected by the user from among the at least one first image stored in the storage medium.

3. The information processing apparatus according to claim 1, wherein
the controller transmits the at least one first image stored in the storage medium to a terminal of the user in response to a request from the terminal of the user.

4. The information processing apparatus according to claim 1, wherein
the controller extracts the at least one first image having the same feature as the feature of the image posted by the user from among the images taken by the camera, by making a comparison between a feature amount of the image posted to the social networking service by the user and feature amounts of the images taken by the camera.

5. The information processing apparatus according to claim 1, wherein
the controller obtains, in the social networking service, information about the number of times social buttons have been pressed for the image posted by the user, and stores, in the storage medium, an image having the same feature as the image for which a predetermined number or more of the social buttons have been pressed.

6. The information processing apparatus according to claim 5, wherein
the controller generates, based on the image posted to the social networking service by the user and the number of times the social buttons have been pressed for the image posted by the user, a learning model that outputs whether or not the number of times the social buttons are pressed for an input of the image is equal to or greater than the predetermined number.

7. An information processing method for causing a computer to perform:
obtaining an image posted by a user in a social networking service; and
storing, in a storage medium, at least one first image having the same feature as a feature of the image posted by the user among images taken by a camera that is provided in a vehicle associated with the user and installed toward an outside of the vehicle.

8. The information processing method according to claim 7, wherein
the computer transmits, to the social networking service, a second image selected by the user from among the at least one first image stored in the storage medium.

9. The information processing method according to claim 7, wherein
the computer transmits the at least one first image stored in the storage medium to a terminal of the user in response to a request from the terminal of the user.

10. The information processing method according to claim 7, wherein
the computer extracts the at least one first image having the same feature as the feature of the image posted by the user from among the images taken by the camera, by making a comparison between a feature amount of the image posted to the social networking service by the user and feature amounts of the images taken by the camera.

11. The information processing method according to claim 7, wherein
the computer obtains, in the social networking service, information about the number of times social buttons have been pressed for the image posted by the user, and stores, in the storage medium, an image having the same feature as the image for which a predetermined number or more of the social buttons have been pressed.

12. The information processing method according to claim 11, wherein
the computer generates, based on the image posted to the social networking service by the user and the number of times the social buttons have been pressed for the image posted by the user, a learning model that outputs whether or not the number of times the social buttons are pressed for an input of the image is equal to or greater than the predetermined number.

13. A system comprising:
a server configured to manage a social networking service; and
an in-vehicle device provided in a vehicle associated with a user;
wherein the in-vehicle device includes a controller configured to perform:
obtaining an image posted by the user in the social networking service from the server; and
storing, in a storage medium, at least one first image having the same feature as a feature of the image posted by the user among images taken by a camera that is provided in the vehicle and installed toward an outside of the vehicle.

14. The system according to claim 13, further comprising:
a terminal that is used when the user uses the social networking service;
wherein the terminal transmits a request for transmission of the at least one first image stored in the storage medium to the in-vehicle device; and
the controller transmits the at least one first image stored in the storage medium to the terminal in response to a request from the terminal.

15. The system according to claim 14, wherein
the terminal is configured to perform:
displaying the at least one first image received from the in-vehicle device; and
obtaining a second image selected by the user from among the at least one first image thus displayed.

16. The system according to claim 15, wherein
the terminal transmits the second image selected by the user to the social networking service.

17. The system according to claim 13, wherein
the controller extracts the at least one first image having the same feature as the feature of the image posted by the user from among the images taken by the camera, by making a comparison between a feature amount of the image posted to the social networking service by the user and feature amounts of the images taken by the camera.

18. The system according to claim 13, wherein
the controller obtains, in the social networking service, information about the number of times social buttons have been pressed for the image posted by the user, and stores, in the storage medium, an image having the same feature as the image for which a predetermined number or more of the social buttons have been pressed.

19. The system according to claim 18, wherein
the controller generates, based on the image posted to the social networking service by the user and the number of times the social buttons have been pressed for the image posted by the user, a learning model that outputs whether or not the number of times the social buttons are pressed for an input of the image is equal to or greater than the predetermined number.

20. The system according to claim 13, wherein
the controller transmits the at least one first image stored in the storage medium to the server.
